(19) United States
(12) Patent Application Publication
(10) Pub. No.: US 2002/0148634 A1
(43) Pub. Date: Oct. 17, 2002

(54) Battery terminal guard

(76) Inventor: Jack Braden, Pompano Beach, FL (US)

Correspondence Address: Robert M. Downey, ROBERT M. DOWNEY, P.A., 150 E. Palmetto Park Road, Suite 350, Boca Raton, FL, 33432, US

(21) Appl. No.: 09/833,467

(22) Filed: Apr. 11, 2001

(51) Int. Cl. H01B 17/00

(52) U.S. Cl. 174/138 F

(57) ABSTRACT

A guard for protectively shielding the terminals of a battery, such as a group 8D battery, includes a pair of generally flat plate members, including a first plate member attachable to the side of the battery and a second plate member positionable to extend in spaced parallel relation above the top of the battery to cover the battery terminals. In one embodiment, the first and second plate members are integrally formed as one rigid piece with the second plate member extending perpendicularly from the first plate member. Apertures formed through the first plate member accommodate access to terminal extensions for side cable connections, and a slot in the second plate member permits passage of an extendible battery handle therethrough. In another embodiment, the first and second plate members are hingedly attached to one another to permit hinged movement of the second plate member between a lowered, shielding position and a raised position to facilitate servicing the battery as well as access to the battery handles.

### BACKGROUND OF THE INVENTION

1. Field of the Invention

The present invention relates to devices for protectively covering battery terminals and, more particularly, to a guard for protectively shielding the terminals of batteries of the type commonly found on buses, trucks, motor homes, large marine vessels, and heavy equipment. More specifically, the present invention relates to a protective terminal shield for size 8D batteries which accommodates for a wide variety of terminal styles, including a standard post, as well as for numerous cable connections from multiple directions.

2. Discussion of the Related Art

Batteries of the type used in automobiles, marine vessels, trucks, buses, heavy equipment and the like usually have a pair of terminals which may be of a post-type or any of a variety of other terminal styles. It is important to shield the terminals in order to reduce the risk of accidental arcing or shorts, which may cause battery and equipment damage as well as possible battery explosion and serious injury. In order to prevent direct exposure of the battery terminals, numerous protective covers or shields have been proposed in the art, most of which are designed to protect a single battery post terminal with a single battery cable connection.

Most battery terminal shields known in the art are manufactured from non-conductive materials such as rubber or plastic and are molded to a specific shape which surrounds the terminal post and battery cable connector. More particularly, the typical battery terminal shield includes a base with an aperture for passage of the battery terminal post therethrough and a hinged cover which closes to protectively surround the battery terminal post and cable connector on the end of the battery cable. The base and cover are molded to provide a passage for a single battery cable outwardly therefrom, in a particular direction. In many instances, the battery shield is held in place by the battery cable and is installed during installation of the battery in the vehicle or equipment. For this reason, terminal shields are not usually attached to the battery during manufacture of the battery and, therefore, the terminals are not protected during shipment and installation.

The well known single post molded terminal covers of the type described above are not always suited for use, particularly on larger batteries. Specifically, the terminal style and number of cable connections to each terminal can vary, depending upon the particular use and installation of the battery. For instance, a size 8D battery may use any of a variety of terminal styles, including a standard post, depending upon whether the 8D battery is installed on a city bus, yacht, mobile home, heavy equipment item, or generator. Furthermore, the number of cables connected to a single terminal may vary depending upon the installation. For instance, on a city bus, there is typically two cables which connect to the terminal. On the other hand, on a yacht, having multiple electrical systems and components, it is not unusual to have as many as eight cables connected to a single terminal.

Presently known battery terminal shield devices fail to accommodate a variety of terminal styles, beyond the traditional post style. Moreover, most battery terminal shields known in the art do not allow for numerous cable connections from multiple directions and at multiple points using various terminal styles.

### SUMMARY OF THE INVENTION

The present invention is directed to a guard for protectively shielding the terminals of a battery, such as a group 8D battery. The terminal guard includes a pair of generally flat plate members, including a first plate member attachable to the side of the battery and a second plate member positionable to extend in spaced parallel relation above the top of the battery and in a manner which shields the terminals from contact with objects placed against or stacked upon the battery. In one embodiment, the first and second plate members are integrally formed so that the second plate member extends perpendicularly from the first plate member. Apertures formed through the first plate member accommodate access to terminal extensions used for side cable connections. A slot in the second plate member permits passage of an extendible battery handle therethrough so that the battery can be lifted and carried with the terminal guard attached. In another embodiment, the first and second plate members are hingedly attached to one another to permit hinged movement of the second plate member between a lowered, terminal shielding position and a raised position to facilitate servicing the battery.

### BRIEF DESCRIPTION OF THE DRAWINGS

For a fuller understanding of the nature of the present invention, reference should be made to the following detailed description taken in conjunction with the accompanying drawings in which:

FIG. 1 is a top, side perspective view showing a first preferred embodiment of the battery terminal guard attached to a group 8D battery;

FIG. 2 is an isolated perspective view showing the battery terminal guard of FIG. 1 partially cutaway in order to illustrate a battery terminal extension on the battery;

FIG. 3 is a top, side perspective view of a second preferred embodiment of the battery terminal guard of the present invention, shown attached to a group 8D battery with multiple cable connections; and

FIG. 4 is an isolated perspective view, showing the battery terminal guard of FIG. 3 in partial cutaway to illustrate the multiple cable connection and battery handle.

Like reference numerals refer to like parts throughout the several views of the drawings.

### DETAILED DESCRIPTION OF THE PREFERRED EMBODIMENTS

Referring to the several views of the drawings, the various embodiments of the battery terminal guard of the present invention are shown attached to a battery 100. The terminal guard is particularly suited for use on group 8D batteries which are commonly used on buses, trucks, large boats and certain types of heavy equipment.

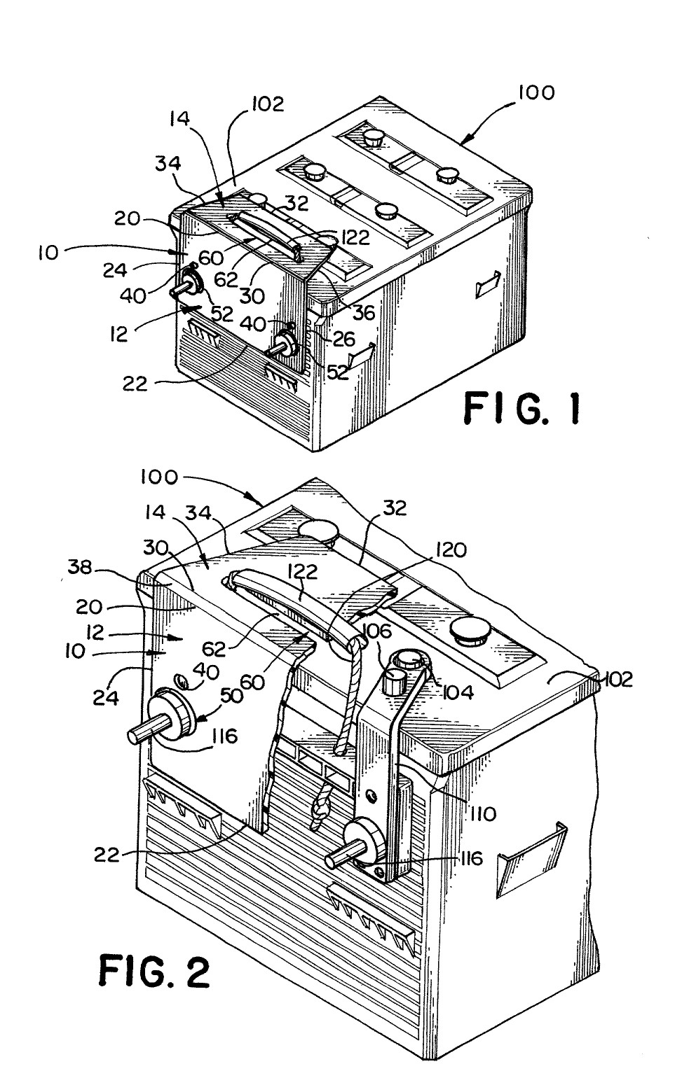

Referring initially to FIGS. 1 and 2, the first preferred embodiment of the battery terminal guard is shown and is generally indicated as 10. The battery terminal guard 10 is preferably formed as an integral one-piece body and includes a first plate member 12 and a second plate member 14. The first plate member includes a top edge 20, a bottom edge 22, and opposite side edges 24, 26. The second plate member 14 includes an outboard edge 30, an inboard edge 32, and opposite side edges 34, 36. In the preferred embodiment, the first and second plate members 12, 14 are formed as an integral unit from a single sheet of non-conductive material, such as ABS plastic or other suitable material, which can be easily molded. In the embodiment shown in FIGS. 1 and 2, the second plate member 14 is angled generally perpendicular to the first plate member 12 by bending the integral sheet of material at the adjacently positioned top edge 20 and outboard edge 30 of the first and second plate members, respectively, thereby defining a bend 38 joining the first and second plate members. Alternatively, the first and second plate members 12, 14 can be joined along the adjacently positioned top edge 20 and outboard edge 30 by heat welding or gluing, to thereby define a seam.

As seen in FIGS. 1 and 2, when the first plate member 12 is attached to the side of the battery, using screws 40, or other conventional fastening means, the second plate member 14 extends over a portion of the top 102 of the battery 100 to cover the terminals 104 (only one of two terminals on the top of the battery is shown in FIG. 2). More specifically, the second plate member 14 extends above the top of the battery, in spaced relation thereto, in a manner which shields the terminals 104 of the battery. However, sufficient space is provided between the second plate member 14 and the top of the battery, to permit passage of multiple battery cables in multiple directions between the second plate member 14 and the battery for connection to the terminals 104, or terminal post 106 on terminal extension members 110. The terminal extension members 110 are used to permit cable connections on the side of the battery. In this instance, the first plate member 12 is attached to the side of the battery, in covering relation to the terminal extension members 110.

Access means 50 formed in the first plate member 12 allows for attachment of one or more of the cables to each of the terminals of the battery. In the embodiment shown in FIG. 2, the access means 50 is defined by a pair of circular apertures 52 formed through the first plate member 12 to permit passage of cable mounts 116 therethrough. The cable mounts 116 are specifically adapted for connection of the cables to facilitate electrical connection of the cables with the terminals 104 of the batteries, via the terminal extension members 110.

The terminal guard 10 is further provided with handle access means 60 for permitting extension of the handle 120 on the side of the battery without having to remove the terminal guard. In the embodiment shown in FIGS. 1 and 2, the handle access means 60 is defined by an elongate slot 62 formed through the second plate member 14, in spaced, parallel relation to the outboard edge 30. The elongate slot is specifically structured and configured to permit passage of the handle grip 122 therethrough so that the handle grip can be grasped above the second plate member.

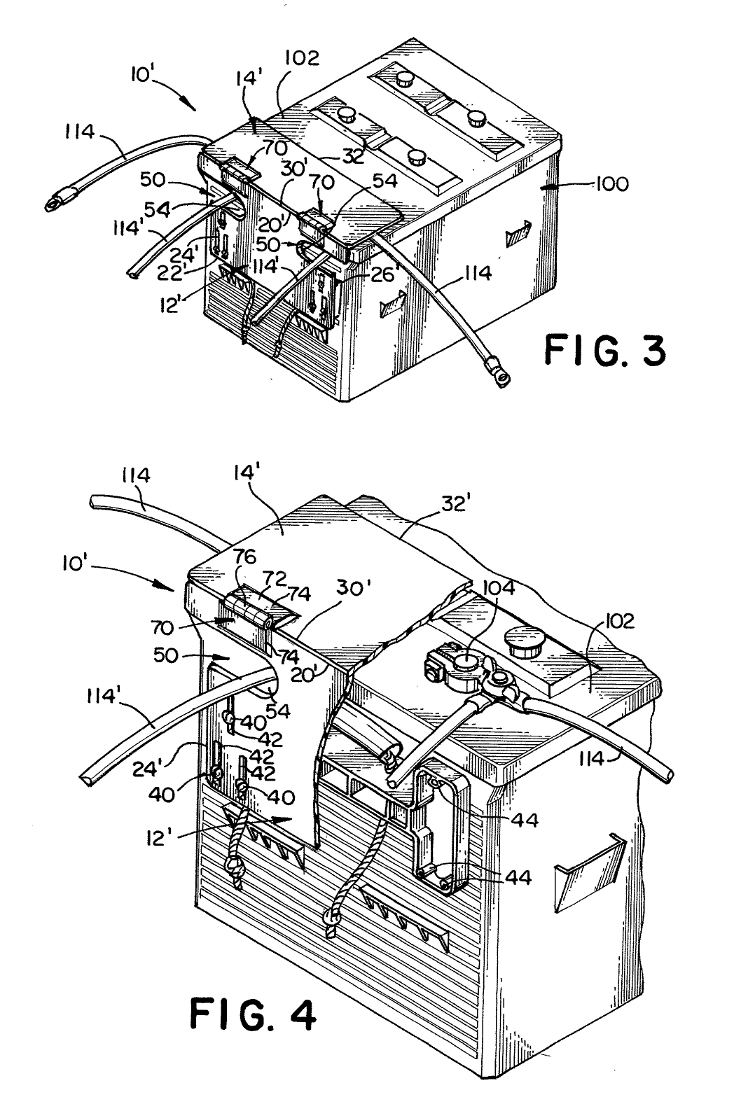

Referring to FIGS. 3 and 4, a second preferred embodiment of the battery terminal guard is shown and is generally indicated as 10′. Similar to the embodiment of FIGS. 1 and 2, the battery terminal guard 10′ includes a first plate member 12′ and a second plate member 14′. In this particular embodiment, the first and second plate members 12′, 14′ are separate pieces which are hinged together, as described more fully hereinafter. The first plate member 12′ includes a top edge 20′, a bottom edge 22′, and opposite side edges 24′, 26′. The second plate member 14′ includes an outboard edge 30′, an inboard 32′, and opposite side edges 34′, 36′.

Similar to the embodiment of FIGS. 1 and 2, the first and second plate members 12′, 14′ are formed from a non-conductive material, such as ABS plastic or other suitable material. The first and second plate members 12′, 14′ are joined along the adjacently positioned top edge 20′ of the first plate member 12′ and the outboard edge 30′ of the second plate member 14′. More specifically, hinge means 70 are provided, including one or more hinges 72 which are attached to both the first plate member 12′ and second plate member 14′, along the correspondingly positioned, adjacent edges 20′, 30′. In the embodiment shown in FIGS. 3 and 4, each hinge 72 is provided with a leaf 74 which attaches to the respective plate member 12′, 14′, using a suitable adhesive, screw fasteners or other conventional attachment means. When the hinges 72 are attached in this manner, the knuckle 76 of the hinge is positioned axially along the juncture between the adjacently positioned edges 20′, 30′. Accordingly, the second plate member 14′ is hingedly movable relative to the first plate member 12′ between a lowered, shielding position, as shown in FIGS. 3 and 4, and a raised position, wherein the second plate member 14′ is generally co-planar with the first plate member 12′ in an upright, vertical position. When the second plate member 14′ is in the raised position, the battery can be easily serviced without removing the terminal guard 10′ from the battery. Moving the second plate member 14′ to the raised position also facilitates connection and disconnection of cables 114 to the terminals 104 of the battery 100, as well as access to the handle grip 122 when the handle 120 is pulled to the extended position for lifting and transporting the battery.

In the embodiment of FIGS. 3 and 4, the access means 50 is defined by elongate openings 54 extending inwardly from the opposite sides 24′, 26′ of the first plate member 12′ to permit passage of cables 114′ outwardly from a side of the battery, as seen in FIGS. 3 and 4.

The first plate member 12′ is adjustably attached to the side of the battery, using screws 40 which are received through elongate slots 42 on the first plate member 12′. The screws 40 are specifically sized for threaded engagement within internally threaded bosses 44 provided on the side of the battery 100. The elongate slots 42 permit sliding vertical adjustment of the first plate member 12′ relative to the screws 40 and the side of the battery to thereby permit selective, adjusted positioning of the first plate member 12′. Adjusting the vertical position of the first plate member 12′ serves to vary the distance between the second plate member 14′ and the top 102 of the battery 100, thereby effectively adjusting the clearance between the second plate member 14′ and the battery terminals 104 and connecting cables 114, as well as any connecting hardware, when the second plate member 14′ is in the lowered, terminal shielding position.

While the instant invention has been shown and described in accordance with preferred and practical embodiments thereof, it is recognized that departures from the instant disclosure are contemplated within the spirit and scope of the present invention as defined in the following claims and as interpreted under the doctrine of equivalents.

What is claimed is:

1. A device for protectively shielding terminals of a battery having a top, a side, and an extendable handle on the side, and wherein cables are connectable to the terminals of the battery, said device comprising:
a first plate member including a top edge, a bottom edge, and opposite side edges, and said first plate member being removably attachable to the side of the battery;
a second plate member including an outboard edge positioned adjacent to said top edge of said first plate, an inboard edge, and opposite side edges; and
means for joining said first and second plate members along said adjacently positioned top and inboard edges, respectively, and said means for joining being structured and disposed for positioning said second plate member in a position which protectively shields the terminals of the battery defined by said second plate member extending in perpendicular relation to said first plate member so that said second plate member extends over a portion of the top of the battery in spaced relation above the terminals.

2. The device as recited in claim 1 further comprising means for permitting extension of the handle on the side of the battery in order to lift and carry the battery.

3. The device as recited in claim 2 further comprising access means formed in said first plate member for accommodating attachment of one or more of the cables to each of the terminals of the battery.

4. The device as recited in claim 3 wherein said access means comprises a pair of elongate openings extending inwardly from said opposite side edges of said first plate member.

5. The device as recited in claim 3 wherein said access means comprises a pair of apertures formed through said first plate member.

6. The device as recited in claim 3 wherein said means for joining comprises a seam integrally joining said first and second plate members along said respective top and outboard edges so that said second plate member is fixed at said terminal shielding position.

7. The device as recited in claim 3 wherein said means for joining comprises an integral bend at said respective top and outboard edges, and said bend maintaining said second plate member fixed at said terminal shielding position.

8. The device as recited in claim 3 wherein said means for joining comprises hinge means hingedly attaching said first and second plate members along said respective top and outboard edges, said hinge means being structured and disposed for permitting hinged movement of said second plate member from said terminal shielding position to a raised position in co-planar relation to said first plate member.

9. The device as recited in claim 2 wherein said means for permitting extension of the handle on the side of the battery comprises an elongate slotted opening formed through said second plate member for permitting passage of the handle therethrough when the handle is extended.

10. The device as recited in claim 1 further comprising adjustable attachment means for adjustably positioning the attachment of said first plate member to the side of the battery to selectively vary a distance between the second plate member and the top of the battery.

11. A device for protectively shielding terminals of a battery having a top, a side, and an extendable handle on the side, and wherein cables are connectable to the terminals of the battery, said device comprising:
a first plate member including a top edge, a bottom edge, and opposite side edges, and said first plate member being removably attachable to the side of the battery;
a second plate member including an outboard edge positioned adjacent to said top edge of said first plate, an inboard edge, and opposite side edges;
means for joining said first and second plate members along said adjacently positioned top and inboard edges, respectively, and said means for joining being structured and disposed for positioning said second plate member in a position which protectively shields the terminals of the battery defined by said second plate member extending in perpendicular relation to said first plate member so that said second plate member extends over a portion of the top of the battery in spaced relation above the terminals; and
access means formed in said first plate member for accommodating attachment of one or more of the cables to each of the terminals of the battery.

12. The device as recited in claim 11 further comprising means for permitting extension of the handle on the side of the battery in order to lift and carry the battery.

13. The device as recited in claim 12 wherein said access means comprises a pair of elongate openings extending inwardly from said opposite side edges of said first plate member.

14. The device as recited in claim 12 wherein said access means comprises a pair of apertures formed through said first plate member.

15. The device as recited in claim 12 wherein said means for joining comprises a seam integrally joining said first and second plate members along said respective top and outboard edges so that said second plate member is fixed at said terminal shielding position.

16. The device as recited in claim 12 wherein said means for joining comprises an integral bend at said respective top and outboard edges, and said bend maintaining said second plate member fixed at said terminal shielding position.

17. The device as recited in claim 12 wherein said means for joining comprises hinge means hingedly attaching said first and second plate members along said respective top and outboard edges, said hinge means being structured and disposed for permitting hinged movement of said second plate member from said terminal shielding position to a raised position in co-planar relation to said first plate member.

18. The device as recited in claim 12 wherein said means for permitting extension of the handle on the side of the battery comprises an elongate slotted opening formed through said second plate member for permitting passage of the handle therethrough when the handle is extended.

19. The device as recited in claim 11 further comprising adjustable attachment means for adjustably positioning the attachment of said first plate member to the side of the battery to selectively vary a distance between the second plate member and the top of the battery wherein said second plate member is in said terminal shielding position.
